(19) United States
(12) Patent Application Publication
(10) Pub. No.: US 2010/0078124 A1
(43) Pub. Date: Apr. 1, 2010

(54) Removable Protective Barrier System and Method

(76) Inventor: Edward Nickolaus, JR., Kenner, LA (US)

Correspondence Address: PATWRITE LLC, 408 W. MAIN ST., MARSHALLTOWN, IA, 50158-5759, US

(21) Appl. No.: 12/566,718

(22) Filed: Sep. 25, 2009

Related U.S. Application Data
(60) Provisional application No. 61/100,316, filed on Sep. 26, 2008.

(51) Int. Cl. B32B 37/00; B32B 38/18

(52) U.S. Cl. 156/249; 156/247

(57) ABSTRACT

A removable protective barrier system and method utilizes a roll of protective polyethylene plastic barrier material called having a water soluble adhesive on one side. In one embodiment a pair of core inserts fit within each end of the roll. Next, the removable protective barrier is applied to a selected portion of the vehicle and pulled and tucked under any curved portions therein. In one embodiment, clear plastic is used with no need to trim lights, license plates, etc since the covered portions remain visible. If an air intake portion such as a grill portion is covered, an opening is cut in the barrier to allow proper air flow. After use, the protective barrier is removed along with any contaminants and bugs that have lodged on the barrier. Multiple layers may be applied. Other vehicle parts may be covered such as mirrors, antennas, etc.

### CROSS REFERENCE TO RELATED APPLICATIONS

This application claims priority and herein incorporates by reference U.S. provisional patent application 61/103,316, filed Sep. 26, 2008.

### BACKGROUND OF THE INVENTION

Modern vehicles travel at a high rate of speed and this leads to many contaminants being deposited on the vehicle's finish such as bugs, tar, road grime, rocks, etc. Removing the bugs and other road debris without hurting the vehicles finish is a real challenge. Some solutions to the problem have been used such as strap on or magnetically attached car protectors commonly referred to as a “Car Bra”. These are generally difficult to install and must be special designed to fit particular vehicles.

There is a need for an easy to use method of protecting any vehicle that is easily removable and that does not cause any permanent damage to the vehicle.

### SUMMARY OF THE INVENTION

A removable protective barrier system and method utilizes a roll of protective polyethylene plastic barrier material called having a water soluble adhesive on one side. In one embodiment a pair of core inserts fit within each end of the roll. Next, the removable protective barrier is applied to a selected portion of the vehicle and pulled and tucked under any curved portions therein. In one embodiment, clear plastic is used with no need to trim lights, license plates, etc since the covered portions remain visible. If an air intake portion such as a grill portion is covered, an opening is cut in the barrier to allow proper air flow. After use, the protective barrier is removed along with any contaminants and bugs that have lodged on the barrier. Multiple layers may be applied. Other vehicle parts may be covered such as mirrors, antennas, etc.

Other features and advantages of the instant invention will become apparent from the following description of the invention which refers to the accompanying drawings.

### BRIEF DESCRIPTION OF THE DRAWINGS

FIG. 1 is a perspective view of a removable protective barrier being applied to a vehicle according to an embodiment of the present invention.

FIG. 2 is a perspective view of the removable protective barrier shown in FIG. 1 as it is further applied to the vehicle.

FIG. 3 is a perspective view of the removable protective barrier shown in FIG. 2 as it is further applied to the vehicle.

FIG. 4 is a perspective view of the removable protective barrier shown in FIG. 3 as it is further applied to the vehicle.

FIG. 5 is a perspective view of the removable protective barrier shown in FIG. 4 with a cutout for air flow.

FIG. 6 is a perspective view of the removable protective barrier shown with bugs and other debris caught therein.

FIG. 7 is a perspective view of the removable protective barrier being removed.

FIG. 8 is a perspective view of multiple layers of the protective barrier being applied to a vehicle.

FIG. 9 is a perspective view of a removable protective barrier being applied to a vehicle according to another embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

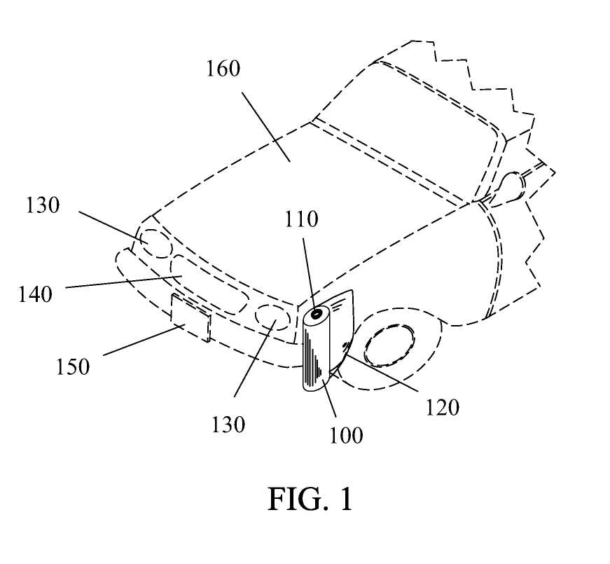

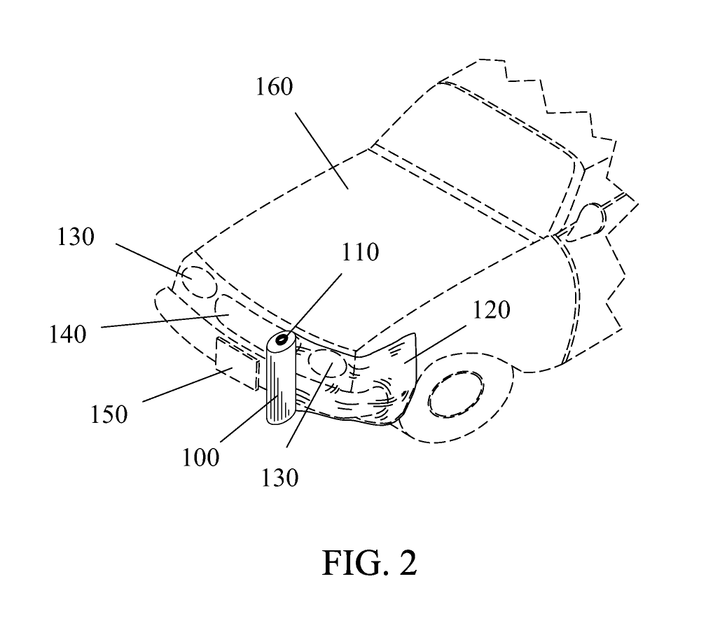

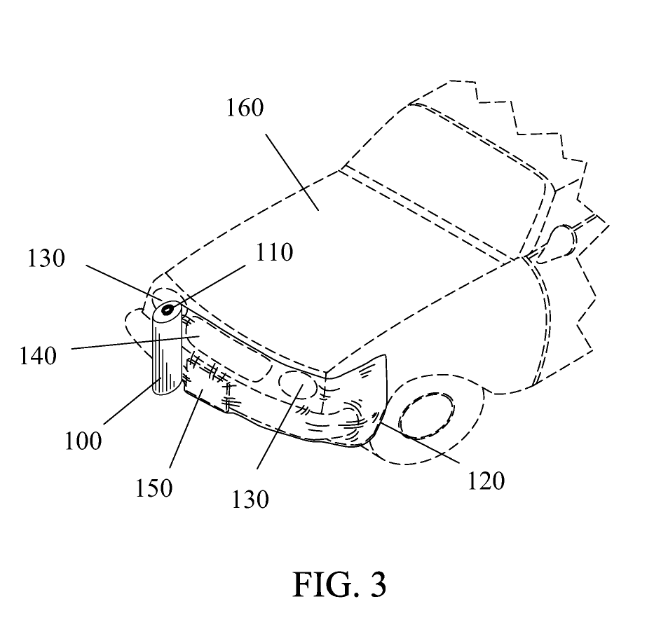

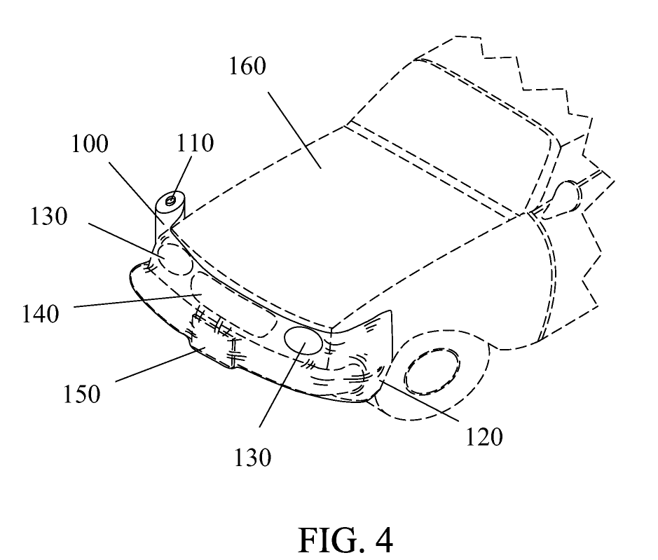

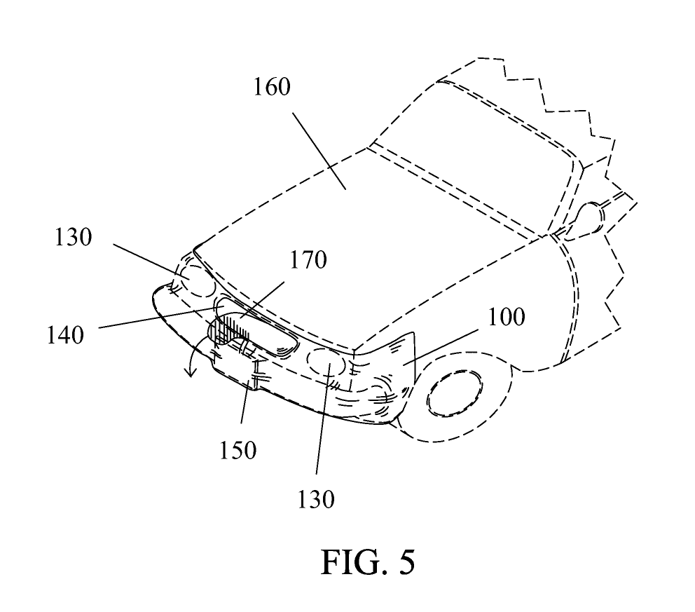

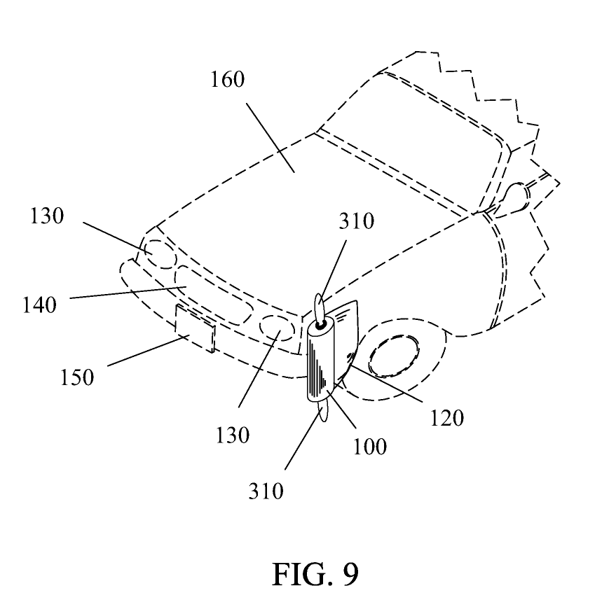

Referring to FIGS. 1 through 5 and 9, a vehicle 160 is shown with a roll of removable protective film barrier 100 being applied. Barrier 100 has removable core inserts 110 (only top core insert is shown) which removeably fits within a top and bottom opening on roll 100 and allow a user to handle and unroll barrier 100. In FIG. 9, an alternative embodiment is shown having handle core inserts 310 inserted within roll 100. Of course other holders may be used as long as they fit within the openings in roll 100. Additionally, it is possible to simply use roll 100 itself by holding it or inserting the fingers into the roll without using any inserts or handles. Curved portions 120 of vehicle 160 are covered with barrier 100 then tucked under to conform to the shape of vehicle 160.

The removable protective barrier 100 is a polyethylene plastic with a water based adhesive backing. The water based adhesive allows removable protective barrier 100 to adhere without permanently adhering to vehicle 160. If any adhesive does adhere to vehicle 160, it may be easily washed away using water. Of course, other adhesives may be used such as solvent based adhesives as long as it easily comes off surface without harming it or leaving a residue. Barrier 100 is clear allowing the color of vehicle 160 to be seen through barrier 100. It is also acceptable to use colored barriers as long as openings are made for lights or other essential operating equipment to function properly. Other acceptable barriers may be used such as polyurethane or other suitable material.

As barrier 100 is being applied on vehicle 160, headlights 130, a license plate 150 and other like vehicle details are covered over. In the embodiment using clear barrier 100, no further action is taken since light shines through barrier 100 with very little reduction in brightness and license plate 150 is visible. This embodiment also has the advantage of keeping headlights 130 and license plate 150 clean. When covering over a grill 140; however, an opening 170 must be made to allow air to flow through grill 140 as designed to regulate engine temperature.

Opening 170 may be completely cut out as shown or simply slotted and folded under to allow airflow. A plastic covered razor knife is used to cut out opening 170. Of course any suitable cutting device such as a scissors, utility knife, etc. may be used as is known in the art. When using an exposed blade device, care must be taken to avoid scratching or marring the surface of vehicle 160 as well as appropriate safety precautions.

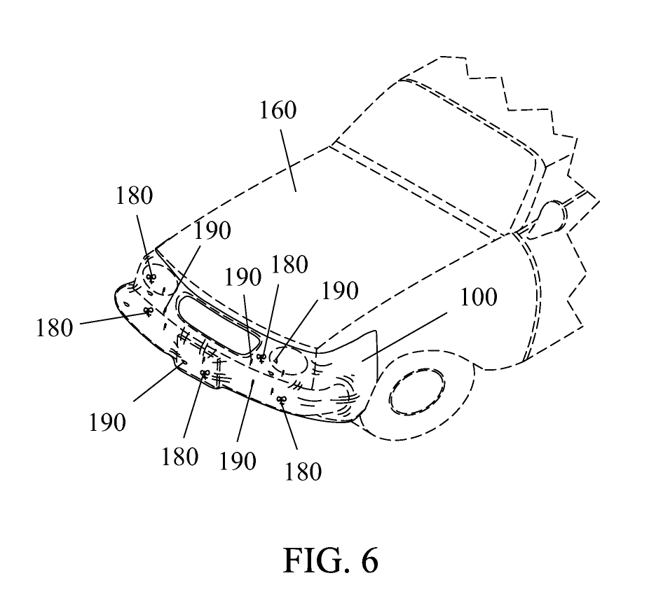

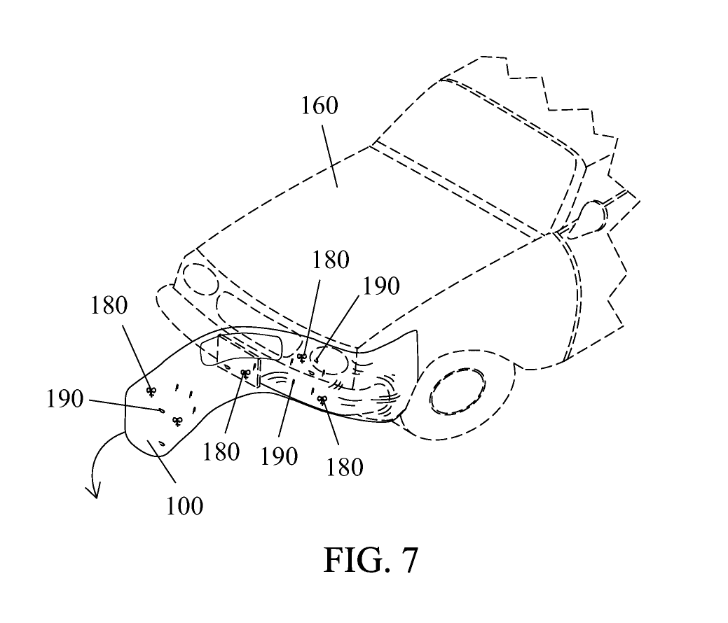

Referring now to FIGS. 6 and 7, protective barrier 100 is shown having a plurality of bugs, dirt and road grime deposited therein. When desired, the user removes barrier 100 to remove all bugs 180, and other contaminants 190 such as tar, dirt, etc. If desired, a new barrier may be applied

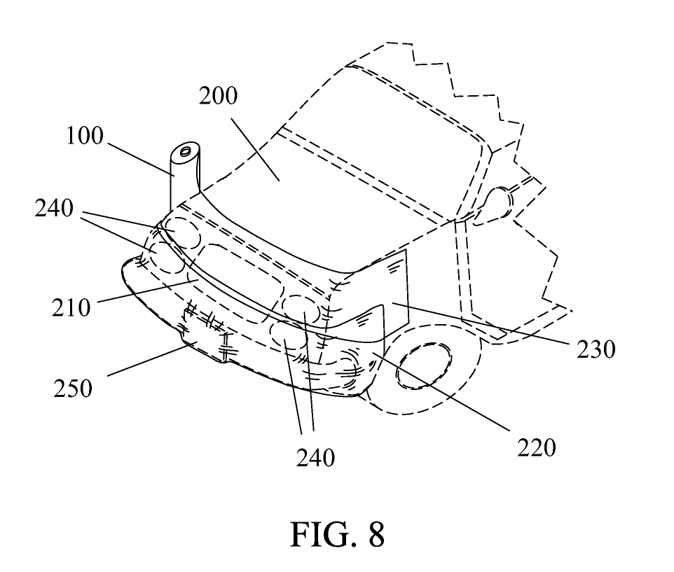

Referring to FIG. 8, multiple layers of protective barrier 100 are shown being applied to a vehicle 200. A first protective barrier layer 220 is applied and then a second protective barrier layer 230 is applied. As before, equipment such as headlights 240 and license plates 250 are covered over without any further step required as long as clear barrier 100 is used. Also, grill 210 must be cut out as discussed above to allow proper airflow. As many layers as desired may be applied to ensure that all desired surfaces are protected.

Additionally, the instant invention is applicable to protecting many different kinds of vehicles such as boats, bikes, recreational vehicles, snowmobiles, water jets, etc as well as protecting specific items such as mirrors, antennas, etc. Also, the vehicle finish and components such as mirrors, antennas and other vehicle equipment are protected from road hazards such as rocks and other road debris hitting them.

Although the instant invention has been described in relation to particular embodiments thereof, many other variations and modifications and other uses will become apparent to those skilled in the art.

What is claimed is:

1. A method of protecting a vehicle using a removable protective barrier comprises the steps of:
obtaining a roll of protective barrier;
said protective barrier having an adhesive applied to one side therein;
said roll having a top opening and a bottom opening;
placing a free end of said protective barrier against said vehicle;
adhering said protective barrier across a portion of said vehicle; and
removing said protective barrier from said vehicle wherein said vehicle is returned to its original condition.

2. The method of protecting a vehicle using a removable protective barrier according to claim 1 further comprising the step of removeably fitting an insert in said top and bottom openings.

3. The method of protecting a vehicle using a removable protective barrier according to claim 1 further comprising the step of adding an additional layer of protective barrier before removing said protective barrier.

4. The method of protecting a vehicle using a removable protective barrier according to claim 1 wherein said adhesive is a water based adhesive.

5. The method of protecting a vehicle using a removable protective barrier according to claim 1 wherein said adhesive is a solvent based adhesive.

6. The method of protecting a vehicle using a removable protective barrier according to claim 1 wherein said protective barrier is made of polyethylene.

7. The method of protecting a vehicle using a removable protective barrier according to claim 1 further comprising the steps of:
selecting at least one additional area on said vehicle to protect; and
applying said protective barrier to said at least one additional area wherein said at least one additional area is protected.

8. The method of protecting a vehicle using a removable protective barrier according to claim 7 wherein said at least one additional area is a mirror.

9. The method of protecting a vehicle using a removable protective barrier according to claim 7 wherein said at least one additional area is an antenna.

10. The method of protecting a vehicle using a removable protective barrier according to claim 1 wherein said vehicle is a boat.

11. The method of protecting a vehicle using a removable protective barrier according to claim 1 wherein said vehicle is an automobile.

12. The method of protecting a vehicle using a removable protective barrier according to claim 1 further comprising the step cutting out a selected air flow area wherein airflow is allowed through said protective barrier.

13. The method of protecting a vehicle using a removable protective barrier according to claim 2 wherein said inserts are handles.

14. A method of protecting of a vehicle using a removable protective barrier system comprises the steps of:
1. obtaining a protective barrier kit;
said protective barrier kit comprising a roll of protective film having an adhesive on one side thereon; a cutting means and an instruction guide for use;
2. adhering a free end of said protective film against a selected area of said vehicle;
3. unrolling said protective film across a portion of said vehicle wherein said film adheres to said portion;
4. cutting said protective film to a selected length wherein said portion is protected; and
5. removing said protective film from said portion wherein said vehicle is returned to an original condition.

15. The method of protecting a vehicle using a removable protective barrier according to claim 14 further comprising the step of adding an additional layer of protective film before removing said protective film.

16. The method of protecting a vehicle using a removable protective barrier according to claim 14 wherein said protective film is made of polyethylene.

17. The method of protecting a vehicle using a removable protective barrier according to claim 14 wherein said adhesive is a water based adhesive.

18. The method of protecting a vehicle using a removable protective barrier according to claim 14 further comprising repeating the said steps 2 through 5 until a desired portion of vehicle is protected.
